(19) United States
(12) Patent Application Publication
(10) Pub. No.: US 2011/0130791 A1
(43) Pub. Date: Jun. 2, 2011

(54) Comforter with a teat part fixed to a mouth shield

(75) Inventors: Guenter Marr, Rosengarten (DE); Eckhard Itzek, Ghyum-Nartum (DE)

(73) Assignee: MAPA GMBH, Zeven (DE)

(21) Appl. No.: 12/919,319

(22) PCT Filed: Feb. 24, 2009
(86) PCT No.: PCT/EP2009/001298

§ 371 Date: Dec. 2, 2010

(30) Foreign Application Priority Data
Feb. 28, 2008 (DE) 10 2008 011 721.8

(51) Int. Cl. A61J 11/00

(52) U.S. Cl. 606/236

(57) ABSTRACT

Comforter with a mouth shield and a hollow teat part which is fixed by means of an insert part in a clamped manner in an opening of the mouth shield, and which comprises a mouth portion, a shaft portion and a peripheral flange arranged at the end of the shaft portion remote from the mouth portion, the teat part having a security strip made of a relatively hard material, which is connected to the mouth portion, extends as far as the region of the flange and has a widening there.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

The invention relates to a comforter with a mouth shield and a hollow teat part which is fixed by means of an insert part in a clamped manner in an opening of the mouth shield, and which comprises a mouth portion, a shaft portion and a peripheral flange arranged at the end of the shaft portion remote from the mouth portion.

Such comforters are, for example, disclosed in the publication DT 25 27 040 A1. Said comforters are characterised by a simple design and by easy fixing of the teat part to the mouth plate by means of the insert part which is frequently also denoted as a clamp. By means of the clamped fixing, materials having different properties, such as for example a very resilient teat part made of latex and a relatively rigid mouth shield made of synthetic material, may be reliably connected together. By the formation of a flange on the teat part in combination with the clamping action of the insert part, the teat part may be reliably prevented from slipping out of the opening of the mouth shield. Problems may, however, occur if the teat part is damaged or weakened as a result of material fatigue. In this case, it may lead to tearing of parts of the teat part in the event of intensive sucking, which is associated with the risk of swallowing or even choking.

A comforter comprising a solid teat part fastened to a mouth plate is disclosed in the publication AT 396 869 B, into which a reinforcement insert which is made of a more solid material and which is fastened to the mouth plate is embedded. The reinforcement insert is positively connected to the mouth plate by means of a cross member which engages in an opening of the reinforcement insert.

A comforter is disclosed in the publication DE 41 33 064 A1, comprising a mouth plate and a hollow teat part which comprises a reinforcement in the form of a thread. The teat part is positioned on the mouth plate, in a manner not disclosed in more detail, the thread being passed through the mouth plate and positively anchored on the rear face of the mouth plate.

A drinking teat is disclosed in the publication WO 95/32702 A1, into which a flexible signalling strip made of a textile material such as a wool fibre or made of a synthetic fibre is embedded. The signalling strip is tear-resistant and preferably has a meshed structure. The teat widens in the direction facing away from the user as far as the relatively large opening diameter of a drinking bottle. In a manner which is conventional in drinking teats, said teat is held at this point on the drinking bottle opening in a clamped manner by a retaining ring. In the event of damage to the teat, a cut-off part of the teat is intended to remain connected by the tear-resistant signalling strip to the remaining part of the teat which is fastened to the drinking bottle.

The use of a security strip in a comforter which is made in one piece is disclosed in the publication DE 42 29 224 A1. In this case, the security strip is made from the same relatively hard material as the mouth shield. The teat part consists of a relatively soft material. The entire teat is produced in a two-component injection-moulding method. The security strip is configured integrally with the mouth shield and thus fixedly connected thereto.

A further comforter made in one piece is disclosed in the publication DE 10 2006 022 669 A1, which comprises a security thread made of a relatively strong material. The security thread is characterised by its particular arrangement which is intended to avoid the security thread being cut through by the teeth of a user. Also this security thread is configured integrally with the mouth shield.

Proceeding therefrom, the object of the invention is to provide a comforter with a mouth shield and a hollow teat part which is fixed by means of an insert part in a clamped manner in an opening of the mouth shield, which permits particularly safe use and is easy to manufacture.

### BRIEF SUMMARY OF THE INVENTION

The comforter according to the invention has a mouth shield and a hollow teat part which is fixed by means of an insert part in a clamped manner in an opening of the mouth shield, and which comprises a mouth portion, a shaft portion and a peripheral flange arranged at the end of the shaft portion remote from the mouth portion, the teat part having a security strip made of a relatively hard material, which is connected to the mouth portion, extends as far as the region of the flange and has a widening there.

The security strip consists of a relatively hard material, i.e. relative to the material of the teat part. It may only be cut through with difficulty by the teeth of a user, and also has a relatively high tear-resistance. The security strip has an elongate shape, the shape of the cross section being of any kind. For example, it may be semi-circular, circular, oval or rectangular. The security strip may extend as far as the end of the teat part remote from the user. The security strip may have a substantially uniform cross section, in particular in the shaft portion of the teat part. The connection of the security strip to the material of the teat part may be a material connection, for example when the teat part is produced in a two-component injection-moulding method. The security strip may also be anchored positively in the material of the teat part. In particular, the widening of the security strip in the region of the flange may produce a positive anchoring of the security strip in the flange of the teat part and/or in the opening of the mouth shield.

The widening of the security strip in the region of the flange is dimensioned and arranged so that the security strip is gripped by the clamping action of the insert part. As a result, the security strip is fixed in the region of the flange. The resistance to extraction of the teat part and of the security strip itself is substantially improved. In this construction, it is not possible for the mouth portion of the teat part connected to the security strip to be completely cut off from the comforter, even when the material of the teat part in the shaft portion is completely cut through in the vicinity of the mouth shield. In this case, by gripping the security strip as a result of the clamping action of the insert part, the security strip is prevented from being able to be detached from the remainder of the teat part remaining in the region of the flange and from being able to be cut off from the mouth shield with the cut-off mouth portion.

The widening of the security strip relates to its shape. For example, the cross section of the security strip may have a widening, thickening or shaping which improves the retention of the security strip in the region clamped between the insert part and the mouth shield. The widening may also be implemented in the form of shaping the security strip which comprises a uniform cross section, namely in the form of a bent-back or curved portion. In combination with the relatively hard material of the security strip, this also leads to an improved resistance to extraction. The widening may be associated with an accumulation of material in the region of the flange. The widening is formed integrally with the security strip.

It is not necessary for the security strip and/or the widening itself to come into contact with the insert part or the mouth shield. The security strip and widening, for example in the region of the flange, may be entirely surrounded by the material of the teat part and yet be gripped by the clamping action.

In one embodiment, at least one part of the widening extends outwards in the radial direction relative to the shaft portion of the teat part. The part of the widening facing radially outwards may partially engage behind the mouth shield. As a result, the resistance to extraction of the security strip is further improved.

According to one embodiment, the security strip inside the flange has at least one extension which is arranged in the plane of the flange. The extension may form the widening of the security strip, but it may also be combined with a further widening of the security strip. The extension is integrally formed with the security strip. By the arrangement of the extension in the plane of the flange, the security strip is clamped over a relatively large surface area between the insert part and mouth shield. The resistance to extraction of the security strip may, as a result, be increased.

In one embodiment, the extension is of annular configuration and surrounds the hollow space inside the shaft portion. The extension may be closed to form a ring. As a result, the extension is clamped in a manner which, in particular, prevents it from being extracted.

In one embodiment, the at least one extension only partially surrounds the hollow space inside the shaft portion. The extension may be in the shape of an annular segment. It does not form an enclosed ring around the hollow space of the shaft portion. As a result, the teat part provided with the security strip may be more easily unmoulded during production: more specifically, an enclosed ring made of the relatively strong material ensures optimum resistance to extraction, but due to the lower resilience of the material of the security strip in comparison with the material of the teat part, is potentially only able to expand with difficulty to a sufficient extent in order to remove the teat part from the core of the mould.

In one embodiment, at one end of the security strip two extensions are present which extend in opposing directions. The two extensions form particularly effective anchoring and increase the resistance to extraction of the security strip.

In one embodiment, the at least one extension extends at least partially outwards in the radial direction relative to the shaft portion. The at least one extension thus protrudes radially outwards over the portions of the security strip arranged in the longitudinal direction of the shaft portion. If the extension is of annular configuration, it in turn has the shape of a flange. The radially outwardly protruding part of the extension may partially engage behind the edges of the opening in the mouth shield and thus lead to a positive locking of the security strip in the mouth part. As a result, the resistance to extraction of the security strip is improved.

According to one embodiment, the security strip is deflected in a U-shaped manner in the region of the mouth portion and both ends of the security strip are arranged in the region of the flange. In this embodiment, preferably each of the two ends have a widening in the region of the flange.

In one embodiment, the security strip follows a contour of the teat part. The security strip may thus be connected to the teat part over its entire path. It is particularly easily inserted into the teat part, only impairs the flexibility of the teat part slightly and leads to a secure connection between the teat part and the mouth shield.

In one embodiment, the security strip extends on the inside of the teat part. The security strip may be spaced apart from the outside of the teat part and may be surrounded by a material layer of the teat part. As a result, a user does not come into contact with the material of the security strip, which permits additional freedom in the selection of material.

In one embodiment, the widening of the security strip is arranged on the inside of the teat part. As a result, on the one hand, direct contact with the widening by the user may be avoided, and, on the other hand, the widening is directly subjected to the clamping insert piece, which may lead to an improved clamping action and thus greater resistance to extraction.

According to one embodiment, the security strip is embedded in the material of the teat part. The security strip may be entirely or partially embedded. “Embedded” means that in cross section the security strip is surrounded on all sides by the material of the teat part. As a result, the security strip is inserted in a particularly fixed manner into the teat part.

In one embodiment, the shaft portion has a flattened cross section and the security strip is arranged on the narrow sides of the shaft portion and in the region of the corresponding lateral portions of the flange. In these regions of the flange, a particularly good clamping action may be achieved. Additionally, a particularly secure positioning of the security strip is produced at a distance from the shaft portion of the teat part which is directly subjected to the teeth of a user.

In one embodiment, the security strip is arranged on the upper face of the teat part. In principle, the security strip may not only be arranged to the side as in the previous embodiment, but may also be arranged on the upper face and/or on the lower face of the teat part. In one embodiment, on the upper face facing the palate during use, the lower face remains particularly soft, which may be advantageous for comfortable use. The arrangement on the upper face may additionally simplify the manufacture of the teat part.

In one embodiment, two or more security strips are present, which are deflected in a U-shaped manner in the region of the mouth portion. When using a plurality of security strips, a high degree of safety may be achieved against cutting-off parts of the teat part, combined with effective deformability of the teat part.

In one embodiment, the first ends of the security strips arranged on one side of the teat part in the region of the flange are connected to a first, common extension and the second ends of the security strips arranged on the opposing side of the teat part in the region of the flange are connected to a second common extension. In this manner, a particularly secure anchoring of the security strips in the region of the flange may be easily achieved in terms of production.

In one embodiment, the teat part consists of a relatively soft silicone and the security strip consists of a relatively hard silicone. In principle, the teat part may be made from any material suitable for teat parts, for example from natural rubber latex. If silicone is used for the teat part, the connection to the material of the security strip may be difficult. In this case, the use of a second, harder silicone material is one solution.

In one embodiment, the relatively soft silicone and the relatively hard silicone have the same resilience. The relatively hard and relatively soft materials differ in their strength, in particular relative to the cutting-through of the material by the teeth. This material property is independent of the resilience, which characterises the resilient deformability of the materials. If a similar resilience or substantially the same resilience is selected for both materials, this may promote, on the one hand, the load-bearing capacity of the connection of the two materials and, on the other hand, the deformability of the teat part made from the two materials may be prevented from being impaired by the security strip made of the relatively hard silicone.

In one embodiment, the teat part consists of silicone and the security strip consists of a heat-resistant synthetic material. Due to the tempering required for curing the silicone, a heat-resistant synthetic material is used. “Heat-resistant” means that the melting point of the synthetic material is above the temperature for the heat treatment of the silicone, for example above 100° C. or 150° C.

In one embodiment, the heat-resistant synthetic material for the security strip is a polyetheretherketone (PEEK). PEEK has a sufficiently high melting point in order to withstand the temperatures during heat treatment of the silicone and has advantageous mechanical properties for use as a security strip.

In one embodiment, the teat part consists of a relatively soft, thermoplastic elastomer and the security strip of a relatively hard synthetic material. When using a thermoplastic elastomer for the teat part, the selection of a compatible synthetic material for the security strip is simpler than when using silicone. For example, a thermoplastic elastomer may also be used for the relatively hard synthetic material. The thermoplastic elastomer of the security strip may have the same base polymer as the thermoplastic elastomer of the teat part. The relatively hard synthetic material may also be PEEK in this embodiment.

In one embodiment, the relatively hard material has a filling material or a fibrous material. As a result, the strength of the security strip may be increased.

### BRIEF DESCRIPTION OF THE SEVERAL VIEWS OF THE DRAWINGS

The invention is described in more detail hereinafter with reference to an exemplary embodiment shown in the figures, in which:

FIG. 1 shows a teat part of a comforter according to the invention in a perspective view;

FIG. 2 shows the teat part of FIG. 1 in a further perspective view;

FIG. 3 shows a detail of a further exemplary embodiment of a teat part according to the invention in a perspective view;

FIG. 4 shows the teat part of FIG. 3 in cross section along the plane denoted in FIG. 3 by A-A;

FIG. 5 shows a further teat part of a comforter according to the invention in a plan view from above; and

FIG. 6 shows the teat part of FIG. 5 in a plan view from the side.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated.

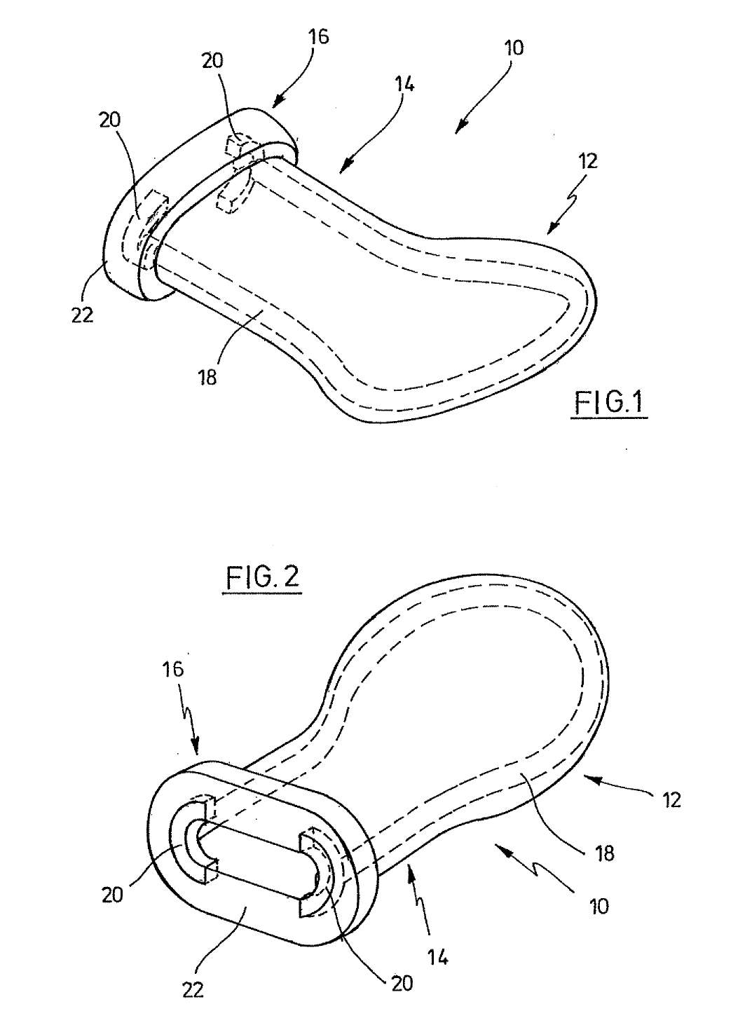

The teat part 10 of FIG. 1 has an orthodontically-shaped mouth portion 12, i.e. adapted to the shape of the oral cavity, which is shown to the right in the figure. The teat part 10 is hollow and consists of a relatively soft material. The mouth portion 12 extends approximately over half of the entire length of the teat part 10. Adjoining the mouth portion 12, the teat part 10 has a shaft portion 14, which has a substantially cylindrical shape. The cross section of the shaft portion 14 is relatively flat. The upper and lower wall of the shaft portion 14 are, in each case, of substantially planar configuration and are connected at the side by, in each case, a curved side wall with a semi-circular cross section. At the end of the shaft portion 14 remote from the mouth portion 12, a flange 16 is located which extends radially outwards from the cross section of the shaft portion 14. The width of the flange 16 in the radial direction approximately corresponds to its length. In the region of the flange 16 the thickness of the wall of the teat part 10, which at this point is entirely formed by the flange 16, is approximately twice the size of that in the region of the shaft portion 12. The hollow space inside the teat part 10 is open at the end of the flange 16 and between the shaft portion 14 and the flange 16 has a uniform path without steps or sudden changes.

In the inside of the teat part 10 extends a security strip 18 separated from the outside over its entire length by a material layer of the teat part 10. The security strip 18 follows the internal contour of the teat part 10 over the entire length of the teat part 10. In the region of the mouth portion 12 and the shaft portion 14, the security strip is arranged on both sides of the teat part 10, and namely at a position which approximately coincides with the greatest width of the teat part 10. The security strip has a substantially uniform, circular or oval cross section in the region of the shaft portion 14 and the mouth portion 12.

The security strip 18 at the front end of the mouth portion 12 is deflected in a U-shaped manner, its two ends extending as far as the region of the flange 16. In the region of the flange 16, each end of the security strip 18 merges with an annular segment-shaped extension 20. Each extension 20 is located in the plane of the flange 16 and extends as far as the rear surface 22 of the flange remote from the mouth portion 12.

Parts of the extension 20 protrude radially outwards over the parts of the security strip 18 extending in the shaft portion 14. Each end of the security strip 18 is connected to the centre of an extension 20, i.e. the two halves of the annular segment-shaped extension 20 extend away from one end of the security strip 18 in opposing directions. Each extension 20 describes a semi-circle, the two open ends of a semi-circular extension 20 opposing the two ends of the other semi-circular extension 20 at a distance from one another. The ends extending into the flange 16 and the annular segment-shaped extensions 20 are widenings of the security strip 18.

In the view of FIG. 2 it may be seen that the annular segment-shaped extensions 20 reach as far as the rear surface 22 of the flange 16. Said extensions are arranged on the inside of the teat part 10 and are spaced apart from the outer side of the flange 16. The security strip 18 is configured integrally with the extensions 20.

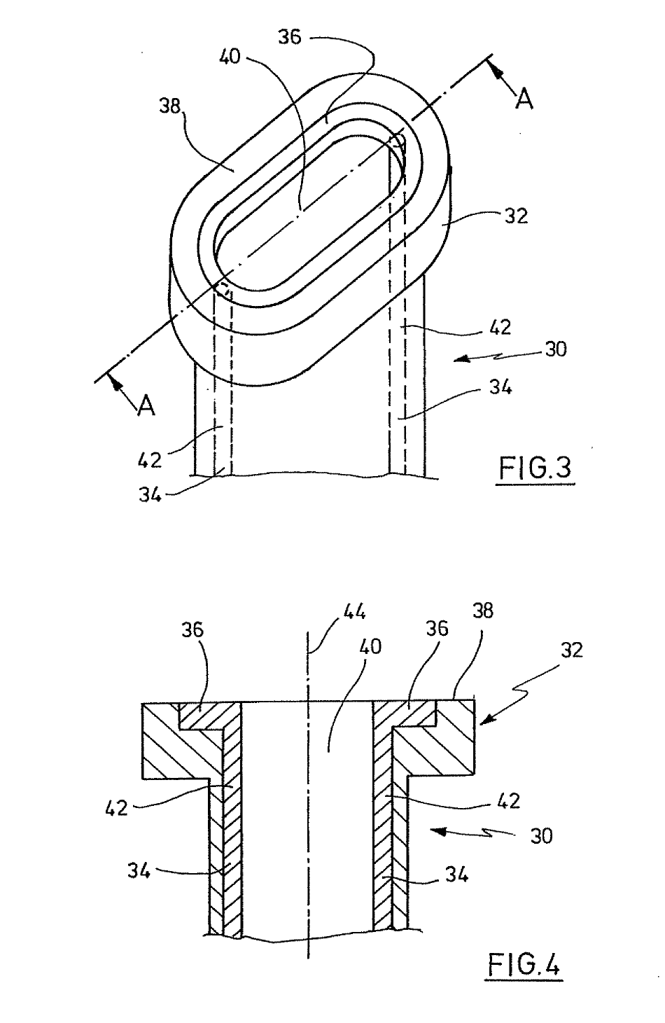

In FIG. 3, a further exemplary embodiment of a teat part for a comforter is sketched. The shaft portion 30 of the teat part is shown and the flange 32 is shown, arranged on the side of the shaft portion 30 remote from the mouth portion of the teat part, not shown. The outer shape of the teat part corresponds to that of the first exemplary embodiment.

On the inside of the shaft portion 30 extends a security strip 34, which has an approximately circular cross section and is embedded in the material of the teat part. The security strip 34 follows the internal contour of the teat part and is deflected in a U-shaped manner in the mouth portion, not shown. The two ends of the security strip 34 continue as far as the region of the flange 32, following the internal contour of the shaft portion 30, where they respectively open into an extension 36 of annular configuration. The extension 36 of annular configuration is located in the plane of the flange 32 and reaches as far as the rear surface 38 of the teat part. The extension 36 completely surrounds the hollow space 40 formed in the inside of the teat part and protrudes partially outwards in the radial direction over the portions 42 of the security strip 34 arranged in the shaft portion 30.

This is clearly visible in the cross section of FIG. 4, which extends along the cutting plane of FIG. 3 denoted by A-A. The portions 42 of the security strip 34 arranged in the shaft portion 30 are arranged substantially parallel to the longitudinal axis of the teat part indicated at 44. The extension 36 extends in the longitudinal direction only over part of the length of the flange 32.

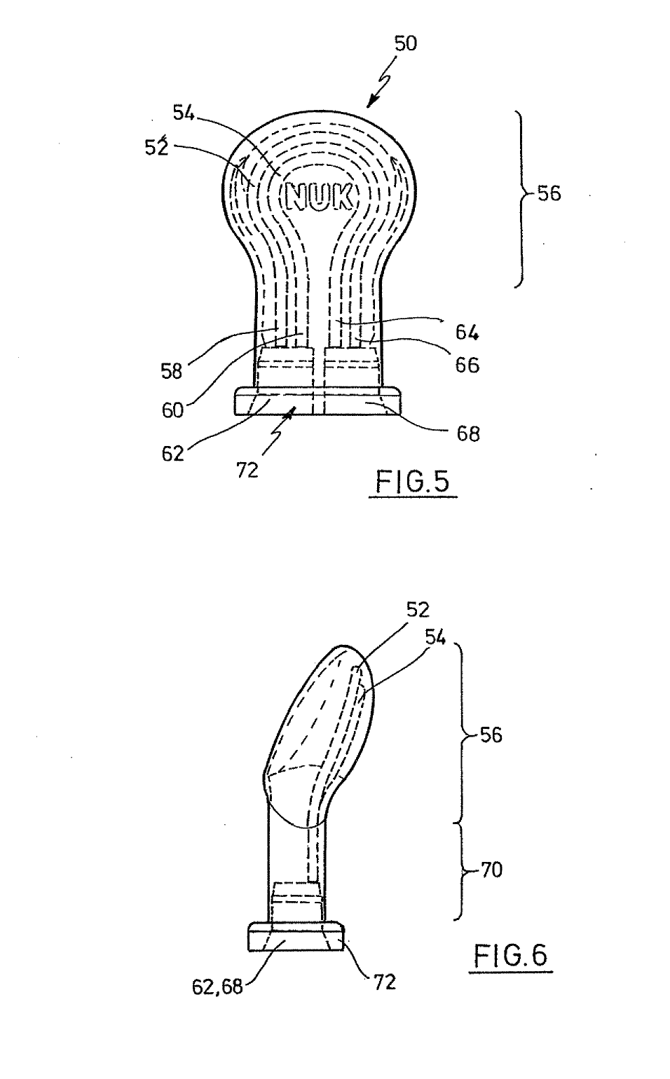

The teat part 50 of the exemplary embodiment shown in FIGS. 5 and 6, has two security strips 52, 54, which are embedded at a uniform distance from one another in the upper face of the teat part 50. In the mouth portion 56, the two security strips 52, 54 are deflected in each case in a U-shaped manner. Each security strip 52, 54 forms a loop. The two first ends 58, 60 of the security strips 52, 54 open into a first extension 62 which is of annular segment-shaped configuration. The two second ends 64, 66 of the security strips 52, 54 open into a second extension 68 which is also of annular segment-shaped configuration. The two security strips 52, 54 and the two extensions 62, 68 are arranged mirror-symmetrically to the median sagittal plane of the teat part 50. The two extensions 62, 68 are spaced apart from one another. In the longitudinal direction of the teat part 50 the two extensions 62, 68 already start in the shaft portion 70 and extend as far as the rear end of the flange 72. In the region of the flange 72, the extensions 62, 68 widen conically outwards.

This completes the description of the preferred and alternate embodiments of the invention. Those skilled in the art may recognize other equivalents to the specific embodiment described herein which equivalents are intended to be encompassed by the claims attached hereto.

1. Comforter with a mouth shield and a hollow teat part (10) which is fixed by means of an insert part in a clamped manner in an opening of the mouth shield, and which comprises a mouth portion (12), a shaft portion (14, 30), a peripheral flange (16, 32) arranged at the end of the shaft portion (14, 30) remote from the mouth portion (12), and a security strip (18, 34) which is connected to the mouth portion (12) and extends as far as the region of the flange (16, 32), characterised in that the security strip (18, 34) consists of a relatively hard material, and in the region of the flange (16, 32) has a widening, the security strip (18, 34) inside the flange (16, 32) having at least one extension (20, 36) which is arranged in the plane of the flange (16, 32) and is of annular or annular segment-shaped configuration and entirely or partially surrounds the hollow space (40) inside the shaft portion (30).

2. Comforter according to claim 1, characterised in that at least one part of the widening extends outwards in the radial direction relative to the shaft portion (14, 30) of the teat part (10).

3. Comforter according to claim 1, characterised in that at one end of the security strip (18, 34) two extensions (20, 36) are present which extend in opposing directions.

4. Comforter according to claim 1, characterised in that the at least one extension (20, 36) extends at least partially outwards in the radial direction relative to the shaft portion (14, 30).

5. Comforter according to claim 1, characterised in that the security strip (18, 34) is deflected in a U-shaped manner in the region of the mouth portion (12) and both ends of the security strip (18, 34) are arranged in the region of the flange (16, 32).

6. Comforter according to claim 1, characterised in that the security strip (18, 34) follows a contour of the teat part (10).

7. Comforter according to claim 1, characterised in that the security strip (18, 34, 52, 54) extends on the inside of the teat part (10) or is arranged on the upper face of the teat part (50).

8. Comforter according to claim 1, characterised in that the widening of the security strip (18, 34) is arranged on the inside of the teat part (10).

9. Comforter according to claim 1, characterised in that the security strip (18, 34) is embedded in the material of the teat part (10).

10. Comforter according to claim 1, characterised in that the shaft portion (14, 30) has a flattened cross section and the security strip (18, 34) is arranged on the narrow sides of the shaft portion (14, 30) and in the region of the corresponding lateral portions of the flange (16, 32).

11. Comforter according to claim 1, characterised in that two or more security strips (52, 54) are present, which are deflected in a U-shaped manner in the region of the mouth portion (56).

12. Comforter according to claim 11, characterised in that the first ends (58, 60) of the security strips (52, 54) arranged on one side of the teat part (50) in the region of the flange (72) are connected to a first extension (62) and the second ends (64, 66) of the security strips (52, 54) arranged on the opposing side of the teat part (50) in the region of the flange (72) are connected to a second extension (68).

13. Comforter according to claim 1, characterised in that the teat part (10) consists of a relatively soft silicone and the security strip (18, 34) consists of a relatively hard silicone.

14. Comforter according to claim 13, characterised in that the relatively soft silicone and the relatively hard silicone have the same resilience.

15. Comforter according to claim 1, characterised in that the teat part (10) consists of silicone and the security strip (18, 34) consists of a heat-resistant synthetic material.

16. Comforter according to claim 15, characterised in that the heat-resistant synthetic material for the security strip (18, 34) is a polyetheretherketone.

17. Comforter according to claim 1, characterised in that the teat part (10) consists of a relatively soft, thermoplastic elastomer and the security strip (18, 34) consists of a relatively hard synthetic material.

18. Comforter according to claim 1, characterised in that the relatively hard material of the security strip (18, 34) has a filling material or a fibrous material.
